(19) United States
(12) Patent Application Publication
(10) Pub. No.: US 2012/0132027 A1
(43) Pub. Date: May 31, 2012

(54) EXTERNAL GEARSHIFT FOR A MANUAL-SHIFT TRANSMISSION

(75) Inventors: Sascha BRUDER, Mainz (DE); Thorsten HAHN, Gau-Odernheim (DE)

(73) Assignee: GM GLOBAL TECHNOLOGY OPERATIONS LLC, Detroit, MI (US)

(21) Appl. No.: 13/303,930

(22) Filed: Nov. 23, 2011

(30) Foreign Application Priority Data
Nov. 29, 2010 (DE) 102010052828.5

(51) Int. Cl. G05G 9/00

(52) U.S. Cl. 74/473.15

(57) ABSTRACT

An external gearshift for a manual-shift transmission has a housing in which a shift selector lever is moveably mounted in two degrees of freedom, to which jackets of two control cables are fastened and in which cores of the two control cables are coupled to the shift selector lever. The housing comprises at least two housing parts fastened to one another, wherein a first of the two housing parts serves for mounting the shift selector lever and the jackets of the control cables are fastened to the second housing part.

### CROSS-REFERENCE TO RELATED APPLICATION

This application claims priority to German Patent Application No. 102010052828.5, filed Nov. 29, 2010, which is incorporated herein by reference in its entirety.

### TECHNICAL FIELD

The technical field relates to an external gearshift for a manual-shift transmission of a motor vehicle.

### BACKGROUND

An external gearshift conventionally comprises a shift selector lever, which can be moved in two degrees of freedom, and whose position determines a gear engaged in the manual-shift transmission, as well as two control cables, which connect the shift selector lever to an internal gearshift of the manual-shift transmission. The precision with which these control cables are able to impose the movement of the shift selector lever onto the internal gearshift is decisive for a comfortable operability of the manual transmission.

Only a limited number of suppliers have the knowledge for producing the control cables and mounting these in an external gearshift so that these are able to control the movements of the internal gearshift with the required precision. In general, the control cables have to be specifically customized and assembled for a given vehicle model in each case. If as a consequence of this the entire external gearshift is to be prefabricated by a single supplier, this results in a considerable logistical expenditures on the part of the vehicle manufacturer, since for each individual vehicle model external gearshifts have to be kept in stock in the quantity required for the running production. Aside from this, additional costs are incurred in that a supplier who is able to customize the control cables in the required quality does not necessarily also have the means in order to cost-effectively supply the remaining components of an external gearshift.

Therefore, at least one object is to state an external gearshift for a manual-shift transmission that is suitable for a split work production by different suppliers. In addition, other objects, desirable features, and characteristics will become apparent from the subsequent summary and detailed description, and the appended claims, taken in conjunction with the accompanying drawings and this background.

### SUMMARY

An external gearshift is provided for a manual-shift transmission having a housing, in which a shift selector lever is mounted moveable, particularly pivotable, in two degrees of freedom, to which jackets of two control cables are fastened and in which cores of the two control cables are coupled to the shift selector lever, the housing comprises at least two parts fastened to each other, wherein a first of the two parts serves as mounting for the shift selector lever with the jackets of the control cables are fastened to the second housing part. This modular structure of the external gearshift on the one hand offers the motor vehicle manufacturer the possibility of having the first housing part with the shift selector lever preassembled thereon produced as a first module and the second housing part with the control cables preassembled thereon as a second module by different suppliers and assemble the two modules during the installation in a motor vehicle or beforehand into the external gearshift himself and in this manner gain cost advantages for himself which are obtained from the possibility of installing identical first modules in many different vehicle models. Alternatively, he can generate advantages in that the circle of possible suppliers for the complete external gearshift is enlarged, since the invention gives a supplier, who himself can only cost-effectively produce the first module, the possibility of procuring the second module from a second supplier.

In order to keep the assembly of the modules simple, a hollow space, in which a headpiece of at least one of the cores of the control cables is coupled to the shift selector lever, is preferentially limited by both housing parts. While, conventionally, of two housing parts of an external gearshift which limit a chamber receiving a pivot ball of the shift selector lever, one also carries the control cables, the first housing part according to the invention is preferentially sub-divided into two elements for limiting such a chamber in order to ensure that the shift selector lever and the first housing part form a handle able unit even when they are not already joined to the second housing part.

Preferentially, a shift handle that is provided for attaching to the shift selector lever and a covering boot are joined into a module that can be assembled on the shift selector lever. This third module combines within itself all equipment features of the external gearshift that can be variable as a function of special wishes of an ordering party of the vehicle, but which are not necessarily specifically for a given vehicle model. Thus, by combining merely three different modules of the first module that is uniform across models, of the second module that is model specific if applicable and of the third module that can be used across models and which is different depending on the ordering party request, the vehicle manufacturer can create all variants of external gearshift that can occur throughout his model range.

### BRIEF DESCRIPTION OF THE DRAWINGS

The present invention will hereinafter be described in conjunction with the following drawing figures, wherein like numerals denote like elements, and:

FIG. 1 a view of a complete external gearshift;

FIG. 2 a view of the external gearshift, disassembled into its modules;

FIG. 3 a view of the housing and of the shift selector lever assembled therein; and

FIG. 4 an exploded representation of the second or shift selector lever module.

### DETAILED DESCRIPTION

The following detailed description is merely exemplary in nature and is not intended to limit application and uses. Furthermore, there is no intention to be bound by any theory presented in the preceding background or summary or the following detailed description.

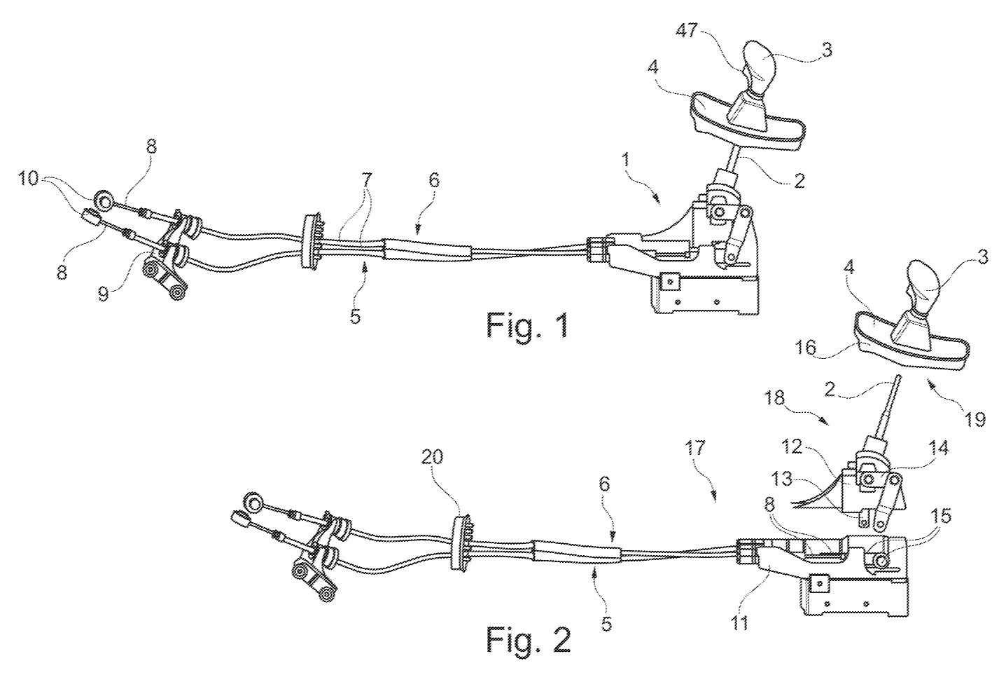

FIG. 1 shows an external gearshift in a lateral view. A housing 1 of the external gearshift is provided in order to be installed in a transmission tunnel (not shown) of a motor vehicle. A shift selector lever 2 protruding upwards out of the housing 1 extends through an opening on the top of the transmission tunnel At the tip of the shift selector lever 2 a shifting handle 3 is fastened. A boot 4 that is connected to the shifting handle 3 and extends all around about the shift selector lever 2 is provided in order to cover the opening of the transmission tunnel and to be fastened to the edges of the opening.

The shift selector lever 2 is pivotably mounted in the housing 1 in two degrees of freedom corresponding to the selection or shifting movement. The selection movement is a pivot movement about an axis running substantially in the paper plane of the drawing; the shifting movement has an axis that is substantially oriented transversely to the paper plane.

Two control cables 5, 6 each have jackets 7 fastened to the housing 1 and cores 8 which are coupled to the shift selector lever 2 in order to be each adjusted by a shifting movement or a selection movement. The jackets 7 end on a yoke 9 provided for fastening to a housing of the manual transmission that is not shown, ends of the cores 8 protruding beyond said yoke carry coupling pieces 10 for attachment to a shifting shaft of the transmission.

FIG. 2 shows the division of the external gearshift into individual modules 17, 18, 19. The housing 1 is subdivided into a basic part 11 and an upper housing part 12. The basic part 11 is fastened in the transmission tunnel and has an inner hollow space that is open towards the top, in which the ends of the cores 8 of the control cables 5 and 6 on the shift lever side and coupling pieces 15 fastened to these are moveably received. The basic part 11 and the control cables 5, 6 fastened to the basic part form the first module 17.

The upper housing part 12 contains a bearing, in which the shift selector lever 2 is held pivotably, but captively, and with the shift selector lever 2 forms the second module 18. A continuation 13 of the shift selector lever 2 protruding downwards out of the housing part 12 acts on the control cable 5 in the inner hollow space of the basic part 11 in order to transmit the shifting movement. A hinged lever 14 pivotably mounted on the housing part 12 is coupled to the selection movement of the shift selector lever 2 and in the assembled state acts on the coupling piece 15 of the control cable 6 in order to transmit the selection movement to the transmission.

The third model 19 comprises the shifting handle 3 and the boot 4 fastened thereon. An outer edge of the boot is formed by a stiff frame 16, which can be engaged in the opening of the transmission tunnel that is not shown. The first module 17 as a rule is specifically matched to a vehicle module in which it is installed, be it through the length of its control cables 5, 6, the position of a flange 20 on the control cables 5, 6 shutting off a passage to the engine compartment or the shape of the basic part 11 matched to the transmission tunnel The second module 18 can be uniformly used in a multiplicity of vehicle models and therefore be economically manufactured in large quantities. Under technical aspects, the third module 19 could likewise be uniform across models.

In practice, a limited number of models of the third module 19 are produced, which differ for example in the materials or their colors used for the shifting handle 3 or the boot 4. A same model of third module 19 can be mounted in different vehicle modules in each case matching in color and/or material to other elements of the passenger compartment.

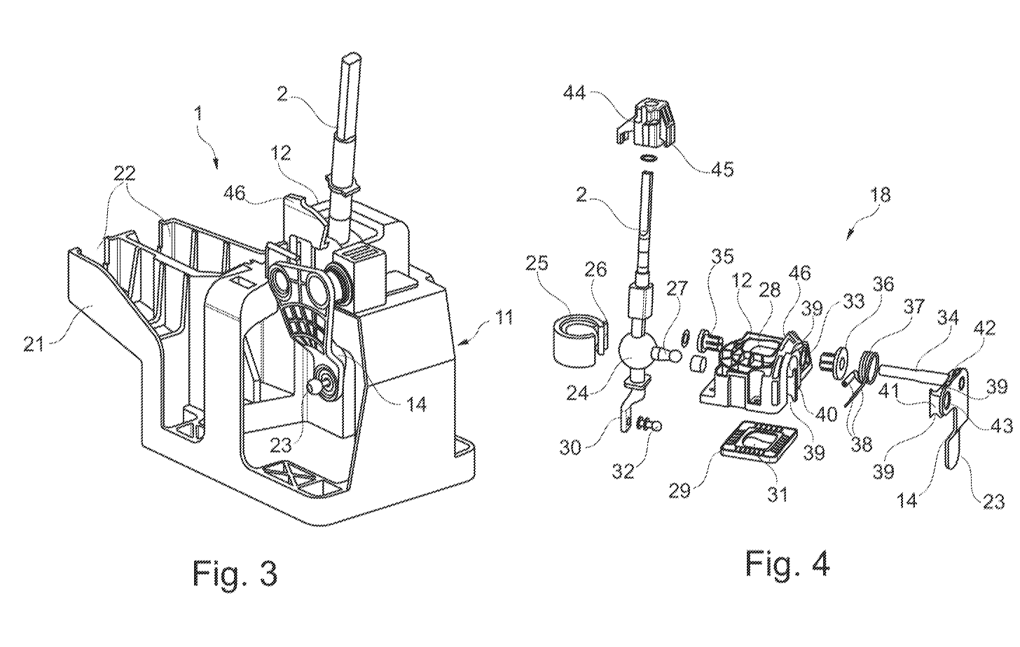

FIG. 3 shows an enlarged perspective view of the housing 1 and the shift selector lever 2 mounted thereon. The basic part 11 of the housing has approximately the shape of a cuboid with an arm 21 standing away in its upper region to the front and towards the engine compartment, in which two channels 22 open towards the top for anchoring the control cables 5, 6 (not shown in the figure) are formed. The hinged lever 14 pivotably attached to the upper housing part 12 engages from the top into a cutout of the basic part 11 and carries, on its lower end in extension of one of the channels 22 a ball head 23, onto which the core of the control cable 6 anchored in the respective channel 22 can be engaged with its coupling piece 15.

FIG. 4 is an expanded representation of the second module 18. The shift selector lever 2 carries a ball 24 in its lower region, which in the ready-assembled state is positively and pivotably received in a holder 25. The outer shape of the holder 25 is substantially cylindrical with a vertical slit 26, from which protrudes in the assembled state a selector finger 27 standing away from the ball 24 at a right angle to the shift selector lever 2. The assembly formed of shift selector lever 2, ball 24, selector finger 27 and holder 25 is provided in order to be introduced into the upper housing part 12 via a spacious opening on its lower side so that the shift selector lever 2 juts out from a smaller opening 28 on the top of the housing part 12. A frame-like insert 29, which following the assembly, is inserted in the bottom opening of the housing part 12 fastened therein in order to partially close it, serves to secure the assembly in the housing part 12. A shifting finger 30 standing away downwards from the ball 24 then extends through the opening 31 of the insert 29. A ball head 32 fastened to the lower end of the shifting finger 30 is provided in order to engage thereon the core of the control cable 5 via its coupling piece 15.

The housing part 12 has a horizontal passage 33, which is provided in order to receive a shaft 34 of the hinged lever 14. Fitted sleeves 35, 36 fix the shaft 34 in the passage 33 in axial direction. A coil spring 37 pushed onto the shaft 34 has two arms 38 standing away in horizontal direction, which engage in each case in upper and lower fillets 39 of a protrusion 40 arranged on a side wall of the housing part and of a protrusion 41 on a horizontal arm 42 of the hinged lever 14. Adjacent to the protrusion 41 a receiving hole 43 for the tip of the selector fingers 27 is formed on the arm 42. By forcing the protrusions 40, 41 into an overlapping position the coil spring 37 defines a neutral position of the selection degree of freedom, which the shift selector lever 2 tends towards when it is not fixed in a shifting position.

The interaction of the shifting finger 27 with the hinged lever 14 converts the selection movement of the lever 2, which is a pivot movement about an axis substantially running in longitudinal direction of the control cables 5, 6, into a translatory movement of the ball head 23 in longitudinal direction of the control cable 6. A sleeve 44 pushed from the top onto the shift selector lever 2 carries a hook 45, which is provided in order to strike against a rib 46 of the housing part 12 during a selection movement of the lever 2. The lever 2 can be brought into a position corresponding to the reverse gear or released from said position only in that the sleeve 44 is lifted over and beyond the rib 46 by means of an unlocking button 47 on the shifting handle 3.

As can be easily seen, the module 18 of all three modules 17, 18, 19 of the internal gearshift is by far the one with most components and the most complicated construction. By standardizing this module 18 across vehicle models and depending on vehicle model or depending on the interior equipment selected by the customer variable features are restricted to the modules 17 and 19, a substantial rationalization can therefore be achieved.

While at least one exemplary embodiment has been presented in the foregoing summary and detailed description, it should be appreciated that a vast number of variations exist. It should also be appreciated that the exemplary embodiment or exemplary embodiments are only examples, and are not intended to limit the scope, applicability, or configuration in any way. Rather, the foregoing summary and detailed description will provide those skilled in the art with a convenient road map for implementing an exemplary embodiment, it being understood that various changes may be made in the function and arrangement of elements described in an exemplary embodiment without departing from the scope as set forth in the appended claims and their legal equivalents.

What is claimed is:

1. An external gearshift for a manual-shift transmission
a housing;
a shift selector lever moveably mounted in the housing in two degrees of freedom on which jackets of two control cables are fastened and in which cores of the two control cables are coupled to the shift selector lever; and
a first housing part fastened to a second housing part,
wherein the first housing part serves to mount the shift selector lever and the jackets of the two control cables are fastened to the second housing part.

2. The external gearshift according to claim 1, wherein a hollow space in which a coupling piece of at least one of the cores of the two control cables is coupled to the shift selector lever is limited by both the first housing part and the second housing part.

3. The external gearshift according to claim 1, wherein the first housing part comprises two elements that jointly limit a chamber in which a body forming a pivot center point of the shift selector lever is received.

4. The external gearshift according to claim 1, wherein a shifting handle and a covering boot are connected into an assembly mountable to the shift selector lever.
